(19) United States
(12) Patent Application Publication
(10) Pub. No.: US 2013/0202049 A1
(43) Pub. Date: Aug. 8, 2013

(54) DISPLAY DEVICE WITH MULTIPLE SIGNAL SOURCES

(71) Applicant: Chin-Tu TSAI, Taoyuan County (TW)

(72) Inventor: Chin-Tu TSAI, Taoyuan County (TW)

(73) Assignee: HERAN CO., LTD., Taoyuan County (TW)

(21) Appl. No.: 13/554,479

(22) Filed: Jul. 20, 2012

(30) Foreign Application Priority Data
Feb. 6, 2012 (TW) 101202127

(51) Int. Cl. H04N 5/66; H04N 7/26

(52) U.S. Cl. 375/240.25; 375/E07.027; 348/E05.133

(57) ABSTRACT

A display device with multiple signal sources includes a display device that includes therein a signal processing unit, an image decoding unit, and a display unit. The signal processing unit is connected to at least two signal terminals that are respectively connected to transmission lines of different signal sources and the signal processing unit synchronously transmits the at least two signal sources to the image decoding unit for carrying out an image decoding operation. Subsequently, the at least two signal sources, after the image decoding, are transmitted to the display unit, so that the display device, when turned on, concurrently displays image windows of the at least two signal sources for reviewing and selection.

### BACKGROUND OF THE INVENTION

1. Field of the Invention

The present invention relates to a display device with multiple signal sources, and more particular to an arrangement that allows a display device to concurrently receive at least two signal sources, whereby the display device, when turned on, may concurrently show image windows of the at least signal sources for reviewing and selection and is applicable to various televisions, displays and the likes.

2. Description of Related Art

Since the time when television sets were made available to the public for watching television programs, transmission of television programs has made a progress from the early days of only few program channels to the more than one hundred channels that are available nowadays. The television viewers now have more options for programs. Also, television sets have also evolved from the early cathode tube era to the liquid crystal televisions that are currently available in the market. This makes the color and image that a television can display finer and more beautiful.

The television, either the early-day cathode tube television, or the modern liquid crystal television, when turned on, only displays the channel which the television stays tuned at the time the television is turned off and shows only a single image. When an attempt is made to watch the programs of other channels, a remote control must be operated to select the channel that the viewer intends to watch. Although some modern liquid crystal televisions comprise multiple to sets of signal terminals to receive different signal sources, pressing down pushbuttons of the remote control is still necessary for switching images between the different signal sources in order to enjoy images of the different signal sources. This makes the viewers frequently operating the remote control for switching programs and the remote control is thus easily susceptible to damage due to such frequent operation.

Thus, in view of the above discussed problems, the present invention aims to provide a display device with multiple signal sources that, when turned on, concurrently displays image windows of at least two signal sources for easy reviewing and selection and allows of easy control by a user.

### SUMMARY OF THE INVENTION

The primary object of the present invention is to provide a display device with multiple signal sources, which comprises an arrangement that a display device concurrently receives at last two signal sources, whereby the display may receive at least two signal sources and the two signal sources are transmitted to a signal processing unit to allow the image processing unit to synchronously transmits the at least two signal sources to an image decoding unit for carrying out an image decoding operation and subsequently, the at least two signal sources, after the image decoding, are transmitted to a display unit, so that the display device, when turned on, may concurrently display image windows of the at least two signal sources for reviewing and selection and thus improving overall practicability of operation.

Another object of the present invention is to provide a display device with multiple signal sources, wherein with the signal sources being an analog television signal, a digital television signal, a cable television signal, or a network television signal, the display device, when turned on, may concurrently display image windows of all the signal sources so that a viewer may review all the image windows at the same time to select any one of these signal sources for watching whereby the frequency of repeated switching among different image window after turn on can be reduced and the overall convenience of operation is enhanced.

In order to achieve the foregoing objects, the present invention provides a display device with multiple signal sources, which comprises a display device that comprises therein a signal processing unit, an image decoding unit, and a display unit and is characterized in that the signal processing unit is connected to at least two signal terminals that are respectively connected to transmission lines of different signal sources and the signal processing unit synchronously transmits the at least two signal sources to the image decoding unit for carrying out an image decoding operation and subsequently, the at least two signal sources, after the image decoding, are transmitted to the display unit, so that the display device, when turned on, may concurrently display image windows of the at least two signal sources for reviewing and selection.

### BRIEF DESCRIPTION OF THE DRAWINGS

The present invention can be fully understood from the following detailed description and preferred embodiment with reference to the accompanying drawings, in which:

FIG. 1 is a schematic view showing selection of image windows with a remote control;

FIG. 2 is a schematic view showing the condition after an image window has been selected;

FIG. 3 is a block diagram showing the architecture of selection with remote control according to the present invention;

FIG. 4 is schematic view showing selection of image windows with touch control; and

FIG. 5 is a block diagram showing the architecture of selection with touch control according to the present invention.

### DETAILED DESCRIPTION OF THE PREFERRED EMBODIMENTS

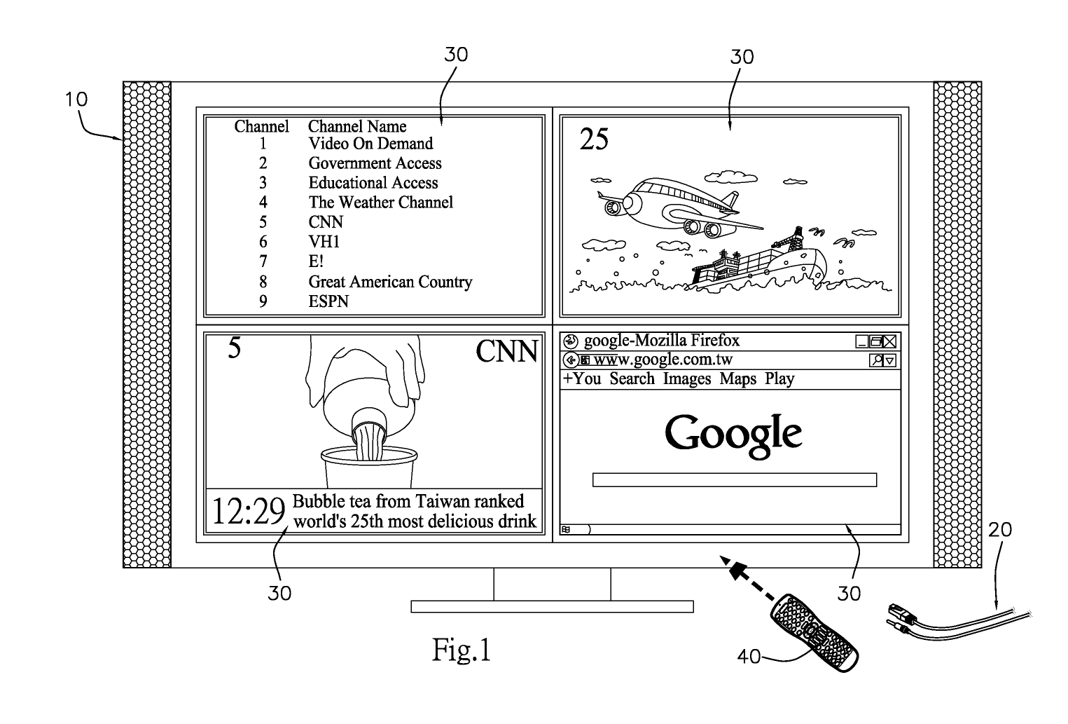

Referring to FIGS. 1-5, the present invention provides a display device with multiple signal sources, which comprises a display device 10. The display device 10 comprises therein a signal processing unit 11, an image decoding unit 12, and a display unit 13 and is characterized in that the signal processing unit 11 is connected to at least two signal terminals 111 that are respectively connected to transmission lines of different signal sources 20 so that the signal processing unit 11 synchronously transmits the at least two signal sources 20 to the image decoding unit 12 for carrying out an image decoding operation. Subsequently, the at least two signal sources 20, after the image decoding, are transmitted to the display unit 13, so that the display device, when turned on, may concurrently display image windows 30 of the at least two signal sources 20 for reviewing and selection.

The signal sources 20 can be anyone of an analog television signal 21, a digital television signal 22, a cable television signal 23, and a network television signal 24. Further, the signal sources 20 to can be any one of a DVI signal 25, a HDMI signal 26, a VGA signal 27, and an AV signal 28. The display device 10 may further comprise an infrared receiver 14 in order to proceed with reviewing and selection of the image windows 30 with the remote control 40. Further, the display device 10 may comprise a touch screen 15 so that selection of the image windows 30 can be carried out with the touch screen 15. Further, the display device 10 can be any one of a liquid crystal display (LCD), a thin-film transistor liquid crystal display (TFT-LCD), an organic light-emitting display (OLED), a low temperature poly-silicon (LTPS) display, a projector display (PD), a vacuum fluorescent display (VFD), a plasma display panel (PDP), and a video display (TV).

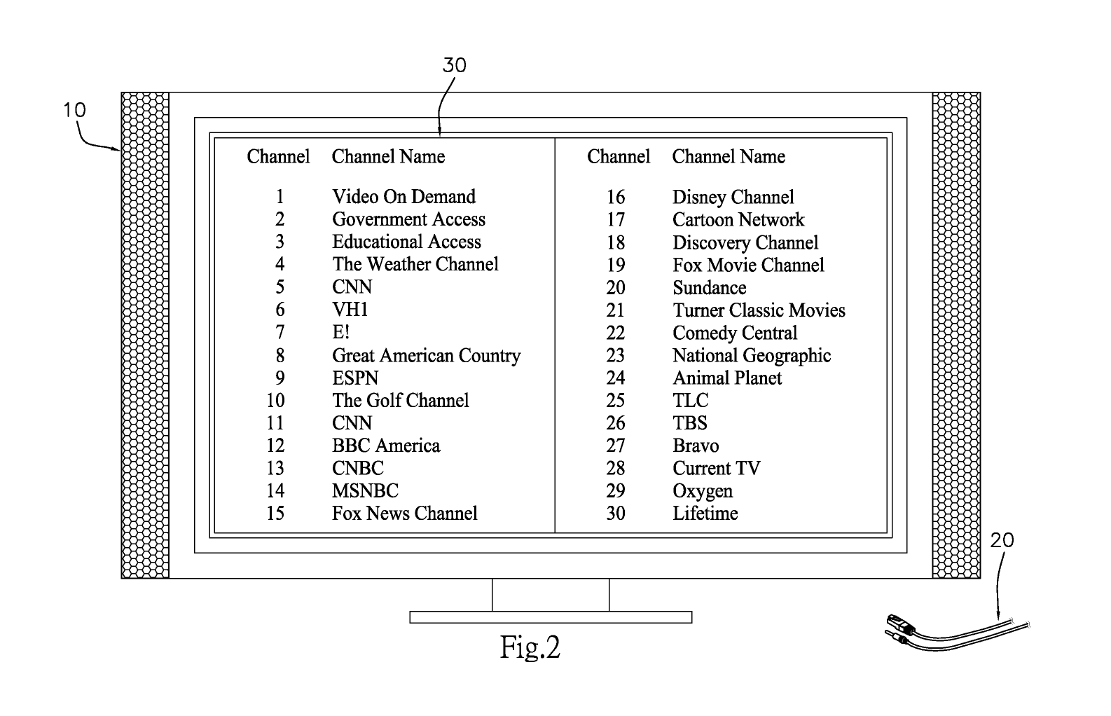

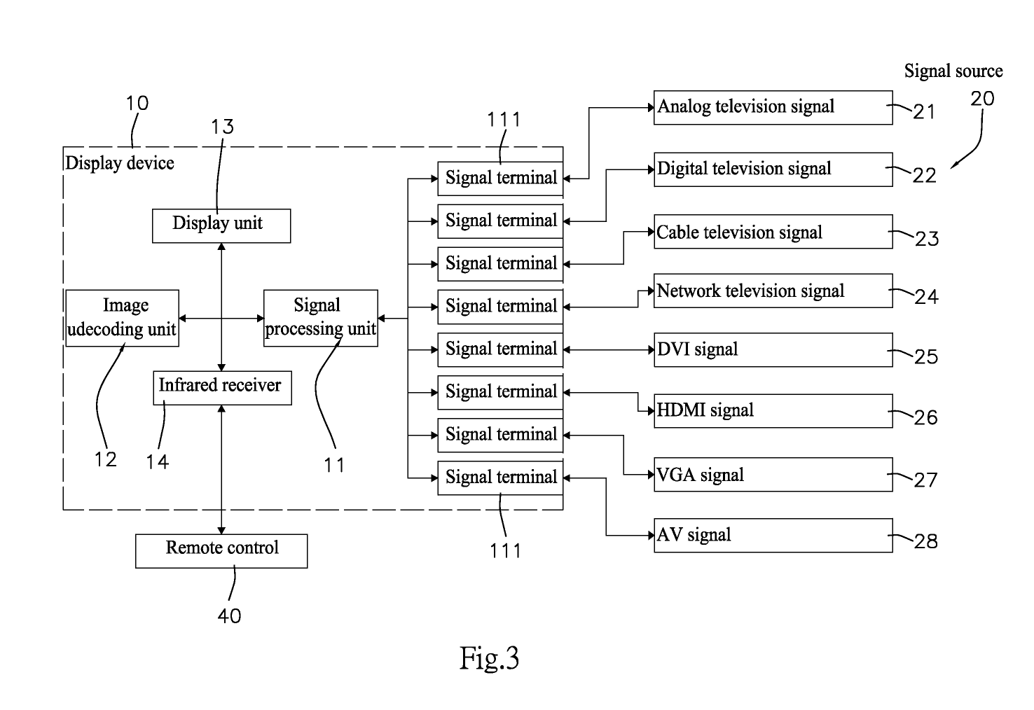

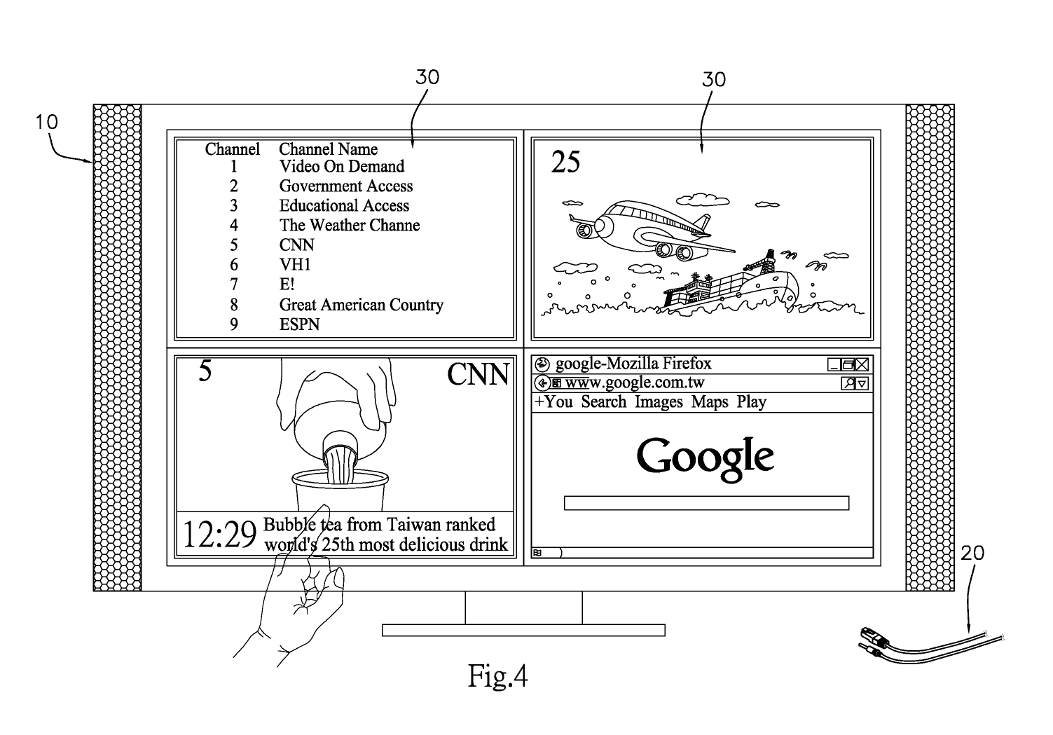

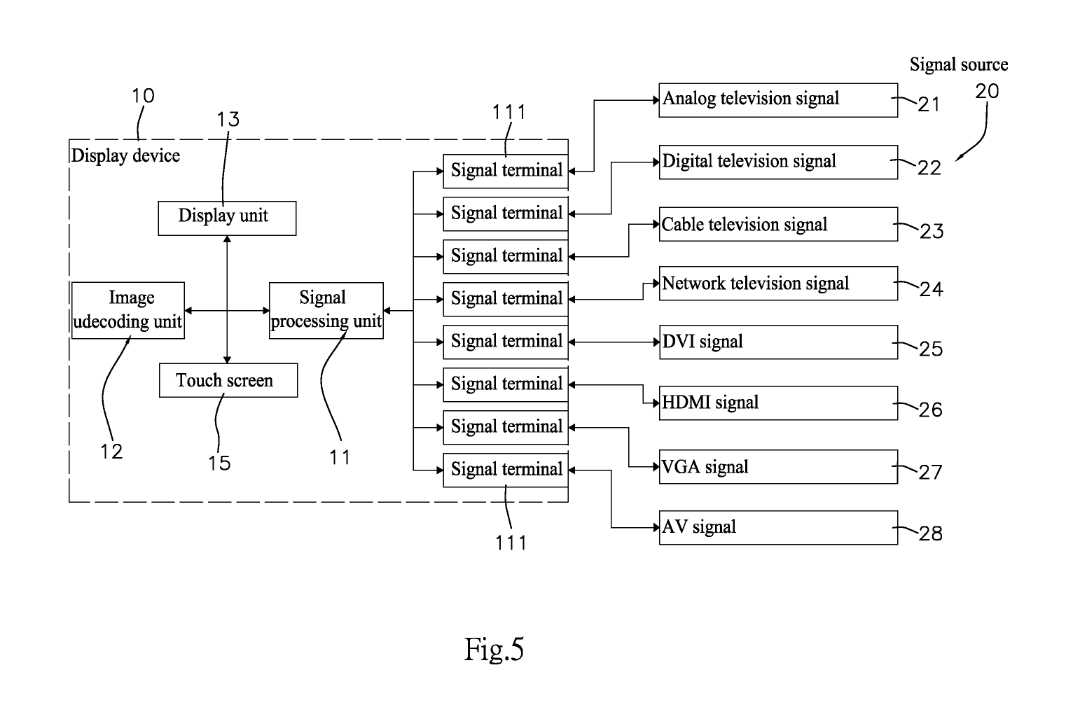

Referring to FIGS. 1-5, the present invention provides a display device with multiple signal sources and a preferred way of practicing the present invention is to be embodied on a display device 10. The display device 10 can be any one of a liquid crystal display (LCD), a thin-film transistor liquid crystal display (TFT-LCD), an organic light-emitting display (OLED), a low temperature poly-silicon (LTPS) display, a projector display (PD), a vacuum fluorescent display (VFD), a plasma display panel (PDP), and a video display (TV). The video display, which is a television set, has the function of watching television programs. The display device 10 comprises therein a signal processing unit 11, an image decoding unit 12, and a display unit 13 and the signal processing unit 11, the image decoding unit 12, and the display unit 13 are interconnected to one another. The signal processing unit 11 is connected to at least two signal terminals 111 that are respectively connected to transmission lines of different signal sources 20 (as shown in FIGS. 3 and 5). The signal sources 20 can be anyone of an analog television signal 21, a digital television signal 22, a cable television signal 23, or a network television signal 24, or any one of a DVI signal 25, a HDMI signal 26, a VGA signal 27, or an AV signal 28. The signal processing unit 11 synchronously transmits the at least two signal sources 20 to the image decoding unit 12 for carrying out decoding operation. Subsequently, the at least two signal sources 20 (or three, four, or all signal sources 20), after the image decoding, are transmitted to the display unit 13, so that the display device 10, when turned on, may concurrently display image windows 30 of the at least two signal sources 20 (as shown in FIGS. 1 and 4), wherein the image windows 30 can be formed through proper division of the screen according to the number of the signal sources 20 to show various arrangements of for example two sub-zones of left and right sides, four sub-zones of upper left, upper right, lower left, and lower right corners, or six sub-zones, eight sub-zones, or nine sub-zones, each of the sub-zones shows one of the signal sources 20. When a viewer turns on the image windows 30 of the display device 10, the viewer may simultaneously view the image windows 30 of all the signal sources 20. With an infrared receiver 14 provided on the display device 10, signal transmitted from the remote control 40 may be used to review and select the image window 30 of one of the sub-zones (as shown in FIGS. 1 and 2) for watching. Alternatively or additionally, the display device 10 comprises a touch screen 15 and the touch screen 15 can be used to select the image window 30 of one of the sub-zones (as shown in FIG. 4) for watching. Thus, the convenience of operation can be improved and the frequency of repeated switching among image windows 30 for searching a desired channel can be reduced to thereby extend the lifespan of the display device 10.

What is claimed is:

1. A display device with multiple signal sources, comprising a display device that comprises therein a signal processing unit, an image decoding unit, and a display unit, and characterized in that the signal processing unit is connected to at least two signal terminals that are respectively connected to transmission lines of different signal sources and the signal processing unit synchronously transmits the at least two signal sources to the image decoding unit for carrying out an image decoding operation and subsequently, the at least two signal sources, after the image decoding, are transmitted to the display unit, so that the display device, when turned on, concurrently displays image windows of the at least two signal sources for reviewing and selection.

2. The display device with multiple signal sources according to claim 1, wherein the signal sources are selected from an analog television signal a digital television signal, a cable television signal, or a network television signal.

3. The display device with multiple signal sources according to claim 1, wherein the signal sources are selected from a DVI signal, a HDMI signal, a VGA signal, and an AV signal.

4. The display device with multiple signal sources according to claim 1, wherein the display device comprises an infrared receiver to proceed with reviewing and selection of the image windows with the remote control.

5. The display device with multiple signal sources according to claim 1, wherein the display device comprises a touch screen so that selection of the image windows is selectively carried out with the touch screen.

6. The display device with multiple signal sources according to claim 1, wherein the display device is selected from a liquid crystal display (LCD), a thin-film transistor liquid crystal display (TFT-LCD), an organic light-emitting display (OLED), a low temperature poly-silicon (LTPS) display, a projector display (PD), a vacuum fluorescent display (VFD), a plasma display panel (PDP), and a video display (TV).
